(19) United States
(12) Patent Application Publication
(10) Pub. No.: US 2015/0141229 A1
(43) Pub. Date: May 21, 2015

(54) SYSTEMS AND METHODS FOR ERECTING A CARTON

(71) Applicant: MeadWestvaco Packaging Systems, LLC, Richmond, VA (US)

(72) Inventors: Michael F. FLAGG, Newnan, GA (US); Bobby L. Miller, Jr., Marietta, GA (US); Rafe T. Patterson, Newnan, GA (US)

(21) Appl. No.: 14/549,638

(22) Filed: Nov. 21, 2014

Related U.S. Application Data
(60) Provisional application No. 61/906,969, filed on Nov. 21, 2013.

(51) Int. Cl. B31B 1/78

(52) U.S. Cl. CPC B31B 1/78
USPC 493/310; 493/309

(57) ABSTRACT

A container erecting system includes a top engaging surface and a bottom engaging surface that fold a collapsed container such as a carton. The top engaging surface moves at a first speed in a downstream direction and the bottom engaging surface moves at a second speed in the downstream direction. The first speed is different from the second speed.

### CROSS REFERENCE TO RELATED APPLICATION

This application claims the benefit of priority under 35 U.S.C. §119(e) of U.S. provisional application Ser. No. 61/906969 filed on Nov. 21, 2013, which is hereby incorporated by reference in its entirety.

### TECHNICAL FIELD

The technical field relates generally to systems and methods for erecting a carton.

### BACKGROUND

Many cartons are formed from child resistant material (e.g., a child resistance (CR) rating of F=1) to prevent access to inserts such as blister cards. For example, such cartons are formed from material that is difficult to tear or break. However, such material is also is difficult to erect squarely in order to load with an insert such as a blister card.

### SUMMARY

Systems and methods disclosed herein are able to prebreak a carton at a high speed. For example, a container erecting system includes a top engaging surface and a bottom engaging surface that fold a collapsed carton. The top engaging surface moves at a first speed in a downstream direction and the bottom engaging surface moves at a second speed in the downstream direction. The first speed is different from the second speed.

According to an exemplary embodiment, a container erecting system includes a first conveying system; a folding wheel including an engaging surface; and a flattening system including a bottom center belt. The bottom center belt includes an engaging surface. The first conveying system is configured to convey a collapsed container to a position at which the engaging surface of the folding wheel is configured to engage a top panel of the collapsed container and the engaging surface of the bottom center belt is configured to engage a bottom panel of the collapsed container. A controller is configured to control a first speed of the engaging surface of the folding wheel in a downstream direction with respect to a second speed of the engaging surface of the bottom center belt in the downstream direction. The first speed is different from the second speed within a folding time period.

The foregoing has broadly outlined some of the aspects and features of the various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE DRAWINGS

FIG. 1 is a perspective view of an exemplary carton.

FIG. 2 is a plan view of blank for forming the carton of FIG. 1.

FIG. 3 is a plan view of a collapsed tubular structure formed from the blank of FIG. 2 that is configured to be folded and secured to form the carton of FIG. 1

FIG. 4 is a schematic side elevation view of an exemplary container erector that is configured to fold and secure the collapsed tubular structure of FIG. 3 to form the carton of FIG. 1.

FIG. 5 is a schematic top view of the container erector of FIG. 4.

FIG. 6 is a partial perspective view of a first conveying system and a flattening system of the container erector of FIG. 4.

FIG. 7 is a partial perspective view of a lug assembly of the first conveying system of FIG. 6.

FIG. 8 is a schematic side elevation view of the first conveying system and the flattening system of FIG. 6.

FIGS. 9 and 10 are partial perspective views of the first conveying system and the flattening system of FIG. 6 illustrating steps of an exemplary method.

FIG. 11 is a schematic partial side elevation view of the flattening system of FIGS. 9 and 10, illustrating steps of the exemplary method.

FIG. 12 is a graphical illustration of the velocity of a folding wheel and a bottom center belt of the flattening system of FIGS. 9 and 10.

### DETAILED DESCRIPTION

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are know to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

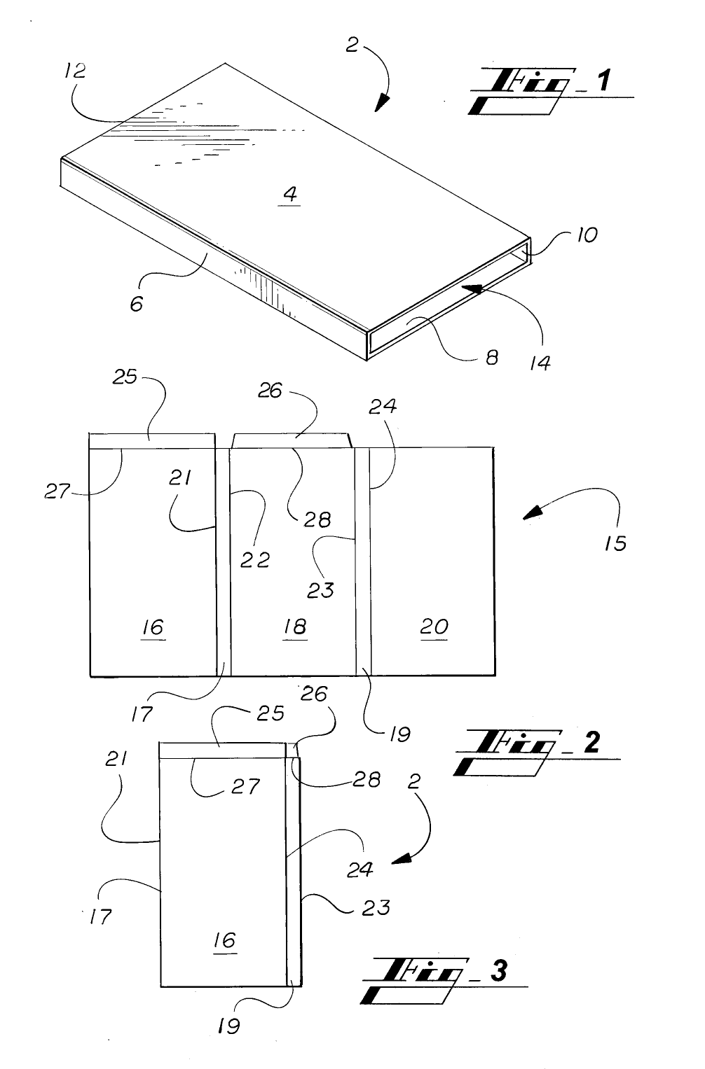

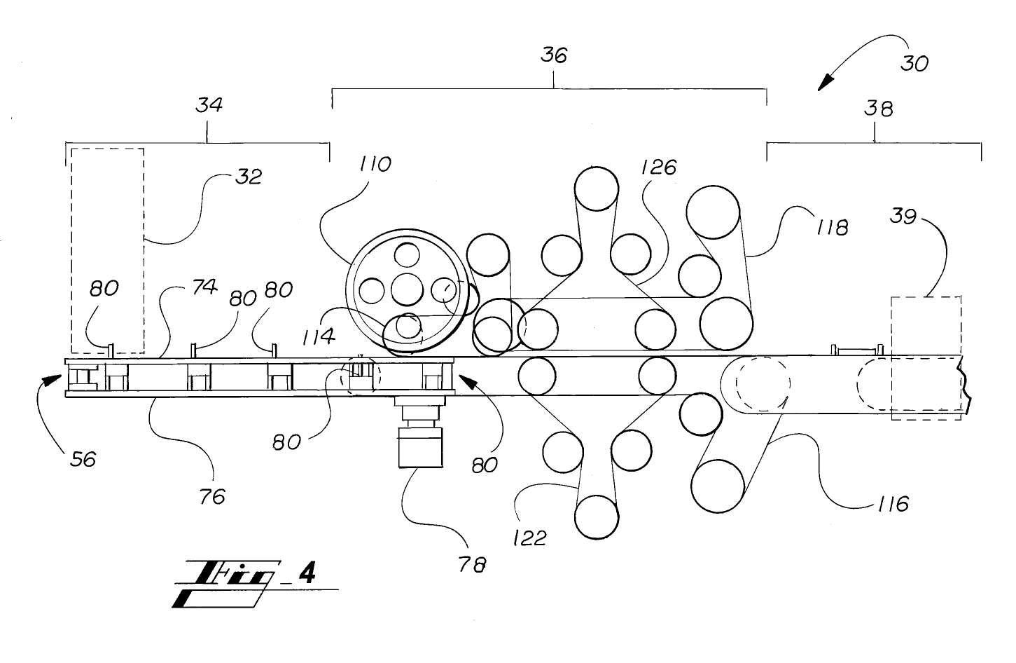

Referring to FIGS. 1 and 2, a carton 2 can be formed from a blank 15, described in further detail below. The carton 2 includes a top wall 4, a first side wall 6, a bottom wall 8, a second side wall 10, and an end wall 12. The top wall 4, first side wall 6, bottom wall 8, and second side wall 10 together form a tubular structure with opposed open ends. One of the open ends is closed by the end wall 12. The other open end is an open end 14. Inserts can be inserted into the carton 2 through the open end 14 and removed from the carton 2 through the open end 14. For example, the carton 2 is configured to house a blister card.

The blank 15 is a foldable sheet of relatively rigid material. Various blank materials can are contemplated to meet the functional needs of the carton 2. For example, the blank 15 is paperboard with a strength that meets child-proofing standards. The blank 15 is cut, scored, folded, and glued to create the carton 2.

The blank 15 includes an outer top panel 16, a first side panel 17, a bottom panel 18, a second side panel 19, and an inside top panel 20 that are hingedly connected one to the next along fold lines. The outer top panel 16 is hingedly connected to the first side panel 17 along a fold line 21, the first side panel 17 is hingedly connect to the bottom panel 18 along a fold line 22, the bottom panel 18 is hingedly connected to the second side panel 19 along a fold line 23, and the second side panel 19 is hingedly connected to the inside top panel 20 along a fold line 24. The outer top panel 16, the first side panel 17, the bottom panel 18, the second side panel 19, and the inside top panel 20 are configured to be folded and secured to form the walls of the tubular structure of the carton 2.

The blank 15 includes a top end flap 25 and a bottom end flap 26. The top end flap 25 is hingedly connected to the outer top panel 16 along a fold line 27 and the bottom end flap 26 is hingedly connected to the bottom panel 18 along a fold line 28. The top end flap 25 and the bottom end flap 26 are configured to be folded and secured to form the end wall 12.

The blank 15 is folded according to a method. The blank 15 is first folded to form a collapsed carton 2 (see FIG. 3). The collapsed carton 2 is then erected and secured in an erected condition by a container erector 30, described in further detail below. Referring to FIG. 2, the inside surface of the blank 15 is illustrated.

Referring to FIGS. 2 and 3, according to a first step of the method, the inside top panel 20 and the second side panel 19 are folded along the fold line 23 so as to overlap the inside surface of the first side panel 17 and the bottom panel 18.

According to a second step of the method, adhesive (or other means for securing) is applied to the outside surface of the inside top panel 20.

According to a third step of the method, outer top panel 16 is folded along fold line 21 to overlap, and is thereby secured to, the outside surface of the inside top panel 20.

Thereafter, the blank 15 is formed as collapsed carton 2. The outer top panel 16 and the inside top panel 20 together form the top wall 4; the first side panel 17 forms the first side wall 6; the bottom panel 18 forms the bottom wall 8; and the second side panel 19 forms the second side wall 10.

### Container Erector

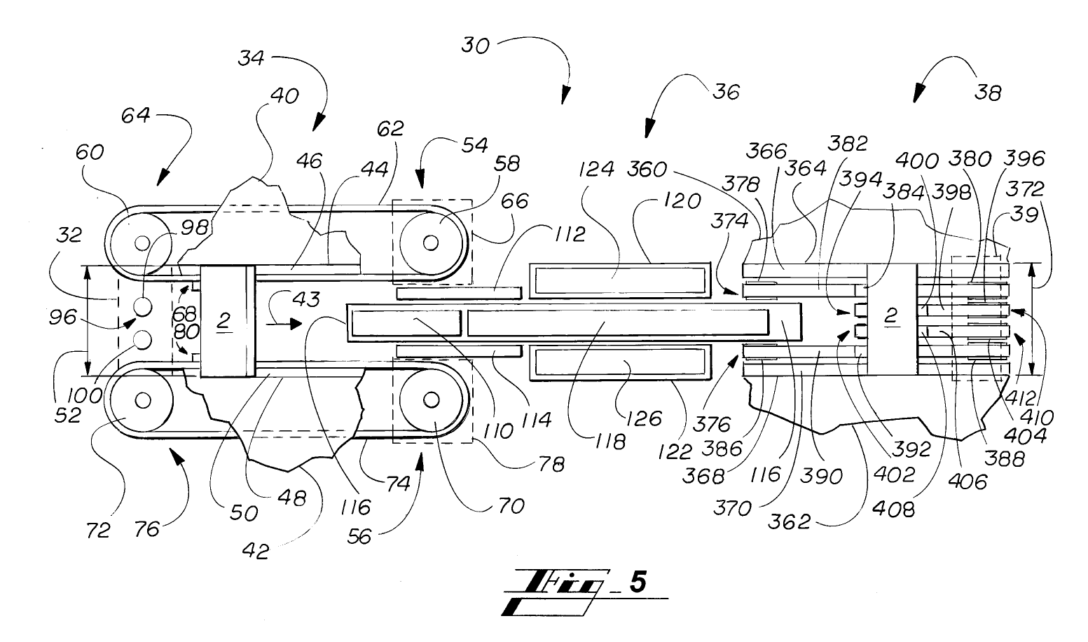

Referring to FIGS. 4-12, the container erector 30 is described in further detail. The container erector 30 includes a hopper 32, a first conveying system 34, a flattening system 36, a second conveying system 38, and a gluing station 39.

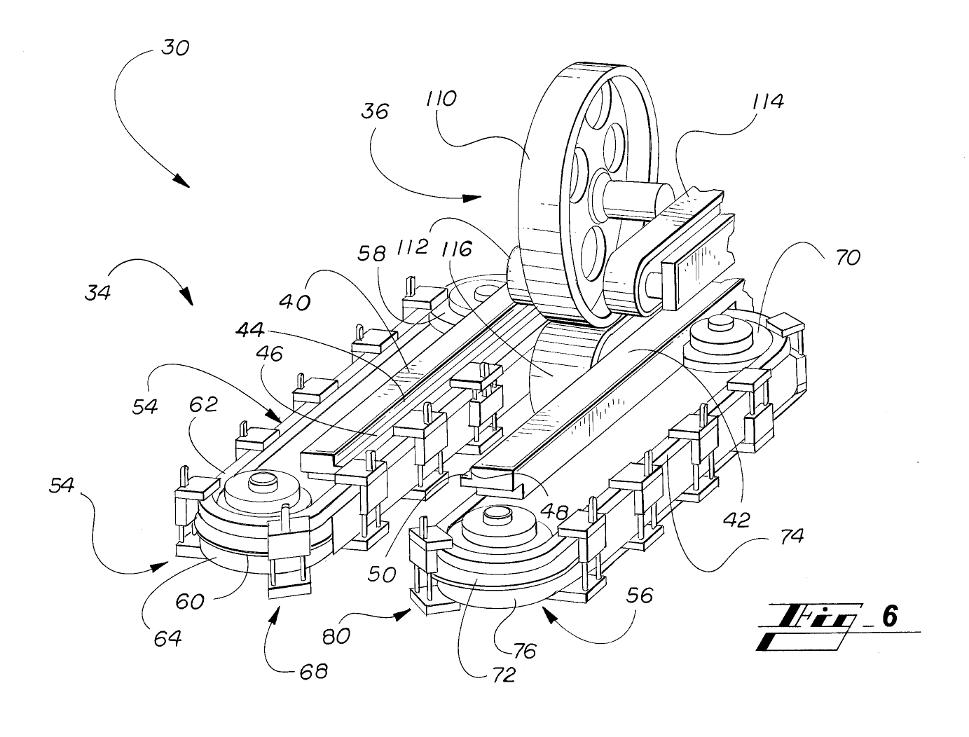

Referring to FIGS. 4-5 the hopper 32 is positioned at the upstream end of the first conveying system 34. The hopper 32 is configured to hold a queue of collapsed cartons 2. The first conveying system 34 is configured to pull a bottom-most collapsed carton 2 from the hopper 32 and convey the collapsed carton 2 to the flattening system 36.

Referring to FIGS. 4-6, the first conveying system 34 includes a first guide 40 and a second guide 42 that are configured to guide a collapsed carton 2 along a path 43 (arrow points in downstream direction). The first guide 40 includes a first lateral support wall 44 and a first bottom support wall 46. The second guide 42 includes a second lateral support wall 48 and a second bottom support wall 50. The first lateral support wall 44 and the second lateral support wall 48 are configured to support opposed end edges of the collapsed carton 2. A width 52 between the first lateral support wall 44 and the second lateral support wall 48 is substantially equal to a distance between end edges of the collapsed carton 2. The first bottom support wall 46 and the second bottom support wall 50 are configured to support the bottom surface of the collapsed carton 2.

The first conveying system 34 further includes a first chain assembly 54 and a second chain assembly 56. The first chain assembly 54 includes a first gear wheel 58 and a second gear wheel 60. The first chain assembly 54 further includes a first chain 62 and a second chain 64 that are tensioned around the first gear wheel 58 and the second gear wheel 60. The first chain 62 and the second chain 64 run in parallel and the first chain 62 is above the second chain 64. The first chain assembly 54 includes a first driving mechanism 66 that is configured to drive the first gear wheel 58. A first lug assembly 68 is attached to the first chain 62 and the second chain 64. As such, the first driving mechanism 66 is configured to move the first lug assembly 68 downstream along the path 43 to move the collapsed carton 2 to the flattening system 36. The first chain assembly 54 includes a plurality of lug assemblies (e.g., see FIG. 6) but, for purposes of clarity, a single lug assembly is shown in FIG. 5.

Similarly, the second chain assembly 56 includes a third gear wheel 70 and a fourth gear wheel 72. The second chain assembly 56 includes a third chain 74 and a fourth chain 76 that are tensioned around the third gear wheel 70 and the fourth gear wheel 72. The third chain 74 and the fourth chain 76 run in parallel and the third chain 74 is above the fourth chain 76. The second chain assembly 56 includes a second driving mechanism 78 that is configured to drive the third gear wheel 70. A second lug assembly 80 is attached to the third chain 74 and the fourth chain 76. As such, the second driving mechanism 78 is configured to move the second lug assembly 80 downstream along the path 43 to move the collapsed carton 2 to the flattening system 36. The second chain assembly 56 includes a plurality of second lug assemblies 80, as shown in FIGS. 4 and 6.

Referring to FIG. 5, the first lug assembly 68 and the second lug assembly 80 are configured to move in parallel along the path 43 to simultaneously contact the collapsed carton 2 and move the collapsed carton 2 downstream along the path 43 from the hopper 32 to the flattening system 36. The first lug assembly 68 and the second lug assembly 80 are substantially the same (e.g., symmetric) and, for purposes of clarity, only the first lug assembly 68 is described in further detail.

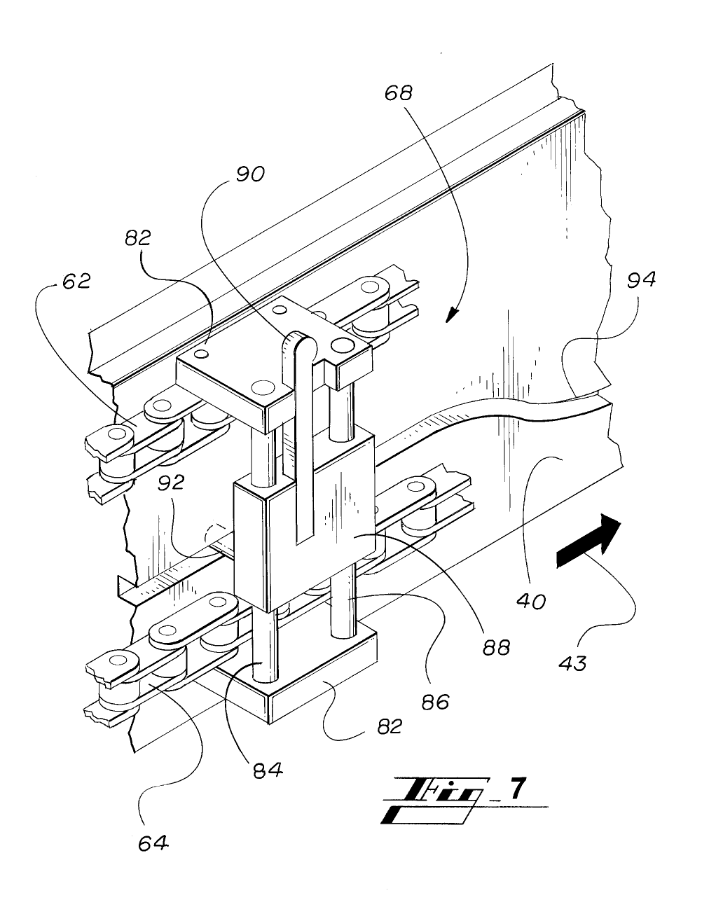

Referring to FIG. 7, the first lug assembly 68 includes upper and lower portions of a base structure 82 that are respectively attached to the first chain 62 and the second chain 64; a first rail 84 and a second rail 86 that extend substantially vertically between the upper and lower portions of the base structure 82; a sliding structure 88 that is configured to slide along the first rail 84 and the second rail 86 between the upper and lower portions of the base structure 82; a lug 90 that extends upwardly from the sliding structure 88; and a roller 92 that is attached to the sliding structure 88 and configured to follow a cam track 94 in the first guide 40. As the first lug assembly 68 moves along the path 43, the cam track 94 defines the vertical position of the lug 90.

Referring to FIG. 5, the first conveying system 34 includes a picker 96 that includes a first suction cup 98 and a second suction cup 100. The picker 96 is configured to raise up, engage a bottom-most collapsed carton 2 in the hopper 32 with the first suction cup 98 and second suction cup 100, drop down to pull the collapsed carton 2 from the hopper 32, position the collapsed carton 2 adjacent the first bottom support wall 46 and second bottom support wall 50, and disengage the first suction cup 98 and the second suction cup 100. The lug 90 of each of the first lug assembly 68 and second lug assembly 80 engage an upstream edge of the collapsed carton 2 to move the collapsed carton 2 downstream along the path 43. Then, then the process repeats for the next bottom-most collapsed carton 2. For example, the picker 96 operates on a cam cycle.

The flattening system 36 is now described in further detail. Generally, the flattening system 36 includes wheels and belts that are configured to fold and flatten the collapsed carton 2. The folding and flattening folds the material of the carton 2 along fold lines and flattens and holds the carton 2 in the folded condition so that the carton 2, upon leaving the flattening system 36, is broken in and can easily be held as a square-cornered tubular structure. For example, the flattening system 36 provides that scores formed in a material of the collapsed carton 2 that has a high degree of resiliency and/or stiffness (e.g., in view of the width to height ratio of the tubular structure) is broken in (e.g., prebroken before engaging with lugs and gluing), overcome, and does not revert to the collapsed condition shown in FIG. 3. For example, the scores are prebroken before the top end flap 25 and the bottom end flap 26 are folded and secured to form the end wall 12 and before an insert is loaded into the open end 14.

Referring to FIGS. 4-6 and 8, the flattening system 36 includes a folding wheel 110 (see FIGS. 6 and 9-11, described in further detail below), a first top folding belt 112, a second top folding belt 114, a bottom center belt 116, a top center belt 118, a first bottom outside belt 120, a second bottom outside belt 122, a first top outside belt 124, and a second top outside belt 126.

With respect to FIG. 5, engaging surfaces of the belts, which are configured to come into contact with the carton 2 are schematically illustrated. An upstream edge of an engaging surface of the folding wheel 110 and an upstream edge of an engaging surface of the bottom center belt 116 are at an upstream end of the flattening system 36. A downstream edge of the engaging surface of the bottom center belt 116 is at a downstream end of the bottom center belt 116.

An upstream edge of an engaging surface of the top center belt 118 is adjacent and downstream from a downstream edge of the engaging surface of the folding wheel 110. The engaging surface of the top center belt 118 and the engaging surface of the folding wheel 110 are each above the engaging surface of the bottom center belt 116.

An upstream edge of an engaging surface of each of the first top folding belt 112 and the second top folding belt 114 is upstream from the downstream edge of the engaging surface of the folding wheel 110. A downstream edge of an engaging surface of each of the first top folding belt 112 and the second top folding belt 114 is downstream from the upstream edge of the engaging surface of the top center belt 118. As such, the first top folding belt 112 and the second top folding belt 114 facilitate a transition of a carton 2 from the folding wheel 110 to the top center belt 118.

An engaging surface of the first top outside belt 124 is above an engaging surface of the first bottom outside belt 120. An engaging surface of the second top outside belt 126 is above an engaging surface of the second bottom outside belt 122. The engaging surface of the first top outside belt 124 is downstream from the engaging surface of the first top folding belt 112. The engaging surface of the second top outside belt 126 is downstream from the engaging surface of the second top folding belt 114.

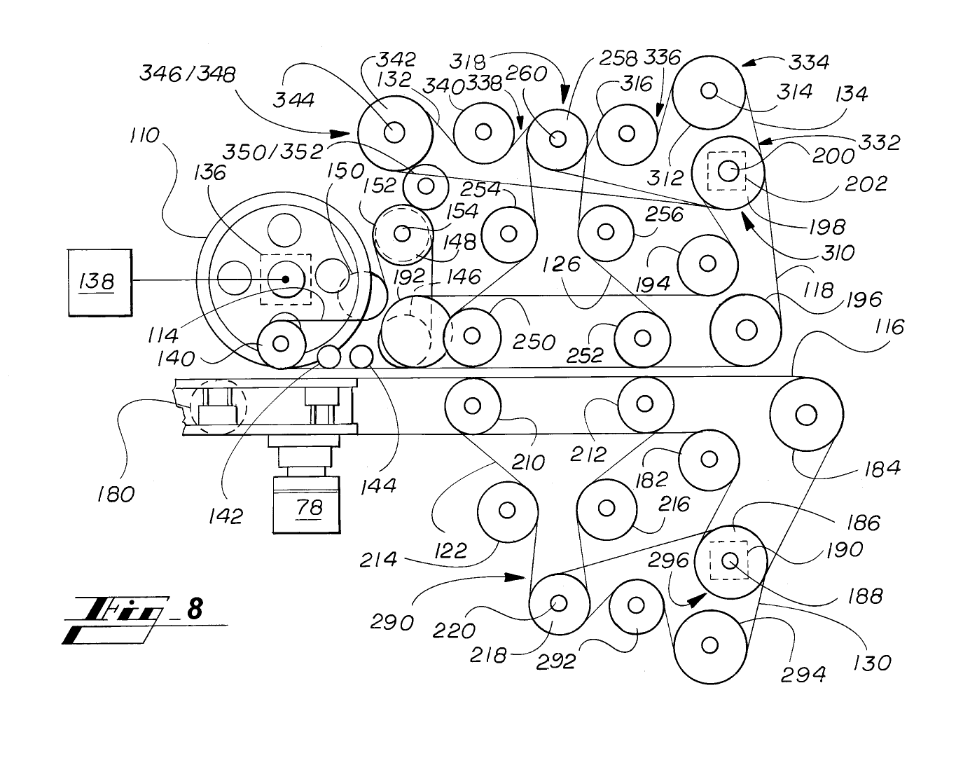

Referring to FIG. 8, the flattening system 36 further includes a first bottom timing belt (not shown), a second bottom timing belt 130, a first top timing belt 132, and a second top timing belt 134. The timing belts keep the first top folding belt 112, the second top folding belt 114, the bottom center belt 116, the top center belt 118, the first bottom outside belt 120, the second bottom outside belt 122, the first top outside belt 124, and the second top outside belt 126 running at the same speed (e.g., velocity v1 in FIG. 12), as described below.

Continuing with FIG. 8, a folding wheel drive 136 is configured to drive the folding wheel 110. A drive control 138 controls an input 139 (see FIG. 12) to the folding wheel drive 136. The drive control 138 also controls input to the belt drives described in further detail below. For example, the drive control 138 provides an input 189 (see FIG. 12) to a bottom belts drive 190 and to a top belts drive 202.

Generally described, the drive control 138 includes a processor that communicates with a memory via, e.g., an address/data bus. The processor can be any commercially available or customer processor. The memory is representative of the overall hierarchy of memory devices containing the software and data used to implement the functionality of the drive control 138. The memory can include, but is not limited to, the following types of devices: processor registers, processor cache, RAM, ROM, PROM, EPROM, EEPROM, flash memory, SRAMD, DRAM, other volatile memory forms, and non-volatile, semi-permanent or permanent memory types; for example, tape-based media, optical media, solid state media, hard disks, combinations thereof, and the like.

The memory may include several categories of software and data used in the drive control 138, including, applications, a database, an operating system (OS), and input/output (I/O) device drivers. As will be appreciated by those skilled in the art, the OS may be any operating system for use with a data processing system. The I/O device drivers may include various routines accessed through the OS by the applications to communicate with devices, and certain memory components. The applications can be stored in the memory and/or in a firmware as executable instructions, and can be executed by the processor. The applications include various programs that, when executed by the processor, implement the various features of the device, including applications for determining the inputs 139, 189.

The applications may be applied to data stored in the database as well as data received via the I/O data ports. The database represents the static and dynamic data used by the applications, the OS, the I/O device drivers and other software programs that may reside in the memory.

While the memory generally resides proximate the processor, it should be understood that at least a portion of the memory can be a remotely accessed storage system, for example, a server on a communication network, a remote hard disk drive, a removable storage medium, combinations thereof, and the like. Thus, any of the data, applications, and/or software described above can be stored within the memory proximate the processor and/or accessed via network connections to other data processing systems that may include a local area network (LAN), a metropolitan area network (MAN), or a wide area network (WAN), for example.

It should be understood that the description above is intended to provide a brief, general description of a suitable environment in which the various aspects of some embodiments of the present disclosure can be implemented. While the description refers to computer-readable instructions, embodiments of the present disclosure also can be implemented in combination with other program modules and/or as a combination of hardware and software in addition to, or instead of, computer readable instructions. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

Continuing with FIG. 8, each of the first top folding belt 112, the second top folding belt 114, the bottom center belt 116, the top center belt 118, the first bottom outside belt 120, the second bottom outside belt 122, the first top outside belt 124, the second top outside belt 126, the first bottom timing belt (not shown), the second bottom timing belt 130, the first top timing belt 132, and the second top timing belt 134 are tensioned around a set of rollers. The illustrated rollers are arranged to facilitate removing, repairing, and replacing the belts. However, the rollers can be alternatively arranged.

The second top folding belt 114 is tensioned around a roller 140, a roller 142, a roller 144, a roller 146, a roller 148, and a roller 150. A gear 152 and the roller 148 are both on an axle 154. The first top folding belt 112 is tensioned around a set of rollers (not shown) that is similar to that of the second top folding belt 114 on the opposite side of the folding wheel 110. Also a gear and one of the rollers around which the first top folding belt 112 is tensioned are both on an axle (not shown).

The bottom center belt 116 is tensioned around a roller 180, a roller 182, a roller 184, and a roller 186. The roller 186 is on an axle 188 that is driven by a bottom belts drive 190. The top center belt 118 is tensioned around a roller 192, a roller 194, a roller 196, and a roller 198. The roller 198 is on an axle 200 that is driven by a top belts drive 202.

The second bottom outside belt 122 is tensioned around a roller 210, a roller 212, a roller 214, a roller 216, and a roller 218. The roller 218 is on an axle 220. The first bottom outside belt 120 is tensioned around a set of rollers (not shown) that is similar to that of the second bottom outside belt 122 on the opposite side of the bottom center belt 116. One of the rollers around which the second bottom outside belt 122 is tensioned is on an axle (not shown).

The second top outside belt 126 is tensioned around a roller 250, a roller 252, a roller 254, a roller 256, and a roller 258. The roller 258 is on an axle 260. The first top outside belt 124 is tensioned around a set of rollers (not shown) that is similar to that of the second top outside belt 126 on the opposite side of the top center belt 118.

The second bottom timing belt 130 is tensioned around a roller 290, a roller 292, a roller 294, and a roller 296. The roller 290 is on the axle 220 such that the roller 218 and the roller 290 rotate together. The roller 296 is on the axle 188 such that the roller 186 and the roller 296 rotate together. The bottom belts drive 190 drives the axle 188 to drive each of the bottom center belt 116 and the second bottom outside belt 122. Particularly, the bottom belts drive 190 drives the axle 188 to drive the second bottom timing belt 130, which drives the second bottom outside belt 122.

The first bottom timing belt (not shown) is tensioned around rollers (not shown) such that the first bottom outside belt and the bottom center belt 116 are driven together. For example, one of the rollers around which the first timing belt is tensioned is on the axle 188 and rotates along with the roller 186 and the roller 296. Another of the rollers around which the first bottom timing belt is tensioned shares an axle with a roller around which first bottom outside belt 120 is tensioned. As such, the bottom belts drive 190 drives the axle 188 to drive the first bottom timing belt, which drives the first bottom outside belt 120.

The second top timing belt 134 is tensioned around a roller 310 on the axle 200, a roller 312 on an axle 314, a roller 316, and a roller 318 on the axle 260. The roller 310 and the roller 198 rotate together on the axle 200. The roller 318 and the roller 258 rotate together on the axle 260. As such, the top belts drive 202 drives the axle 200 to drive the top center belt 118 and the second top outside belt 126.

The first top timing belt 132 is tensioned around a roller 332, a roller 334, a roller 336, a roller 338, a roller 340, and roller 342 on axle 344. The roller 334 is on the axle 314. The roller 338 and a roller around which the first top outside belt 124 is tensioned rotate together on the same axis. As such, the top belts drive 202 drives the axle 200 to drive the second top timing belt 134, which drives the first top timing belt 132, which drives the first top outside belt 124.

A gear 346 and gear 348 are also on the axle 344. The gear 346 meshes with the gear 350 and the gear 348 meshes with the gear 352. In addition, the gear 350 meshes with the gear 152, which is on the axle 154 with the roller 148. Similarly, the gear 352 meshes with a gear (not shown) that is on an axle (not shown) with a roller around which the first top folding belt 112 is tensioned. As such, the top belts drive 202 drives the axle 200 to drive the second top timing belt 134, which drives the first top timing belt 132, which drives the first top folding belt 112 and the second top folding belt 114.

Referring to FIGS. 4 and 5, the second conveying system 38 is described in further detail. The second conveying system 38 includes a third guide 360 and a fourth guide 362. The third guide 360 includes a third lateral support wall 364 and a third bottom support wall 366; the fourth guide 362 includes a fourth lateral support wall 368 and a fourth bottom support wall 370. A width 372 between the third lateral support wall 364 and the fourth lateral support wall 368 is substantially equal to the width 52 or otherwise the width of the carton 2.

The second conveying system 38 includes a third chain assembly 374 and a fourth chain assembly 376. The third chain assembly 374 includes a fifth gear wheel 378 and a sixth gear wheel 380. A fifth chain 382 is tensioned around the fifth gear wheel 378 and the sixth gear wheel 380. A first upstream lug 384 is attached to the fifth chain 382. The fourth chain assembly 376 includes a seventh gear wheel 386 and an eighth gear wheel 388. A sixth chain 390 is tensioned around the seventh gear wheel 386 and the eighth gear wheel 388. A second upstream lug 392 is attached to the sixth chain 390. Generally, more than one upstream lug is attached to each of the fifth chain 382 and the sixth chain 390. For purposes of illustration, a single upstream lug is shown for each of the fifth chain 382 and the sixth chain 390.

The second conveying system 38 includes a fifth chain assembly 410 and a sixth chain assembly 412. The fifth chain assembly 410 includes a ninth gear wheel 394 and a tenth gear wheel 396. A seventh chain 398 is tensioned around the ninth gear wheel 394 and the tenth gear wheel 396. A first downstream lug 400 is attached to the seventh chain 398. The sixth chain assembly 412 includes an eleventh gear wheel 402 and a twelfth gear wheel 404. An eighth chain 406 is tensioned around the eleventh gear wheel 402 and the twelfth gear wheel 404. A second downstream lug 408 is attached to the eighth chain 406. Generally, more than one downstream lug is attached to each of the seventh chain 398 and the eighth chain 406. For purposes of illustration, a single downstream lug is shown for each of the seventh chain 398 and the eighth chain 406.

Referring to FIGS. 9-12, a method of erecting, folding, and securing a collapsed carton 2 is described. Generally, a method uses friction from contact pressure to shear the collapsed carton 2 from the manufacturer's folded condition to a state that is folded one hundred eighty degrees from that position. Once in the one hundred eighty degree folded position, the carton 2 is compressed under moving belts and then released into an erected position.

For purposes of teaching, the folding wheel 110 is illustrated as including a pad 420. The pad 420 is useful for illustrating the motion of the folding wheel 110. However, in some embodiments, the folding wheel 110 is configured such that the entire outside surface of the folding wheel 110 is configured to contact and fold a collapsed carton 2 (e.g., as shown in FIGS. 4, 6, and 8).

Referring to FIG. 9, the first lug assembly 68 and the second lug assembly 80 push the collapsed carton 2 downstream along the first guide 40 and the second guide 42 and then onto the bottom center belt 116 and under the folding wheel 110. The first lug assembly 68, the second lug assembly 80, and the bottom center belt 116 move at the same constant speed (e.g., velocity v1 in FIG. 12) in the downstream direction along the path 43.

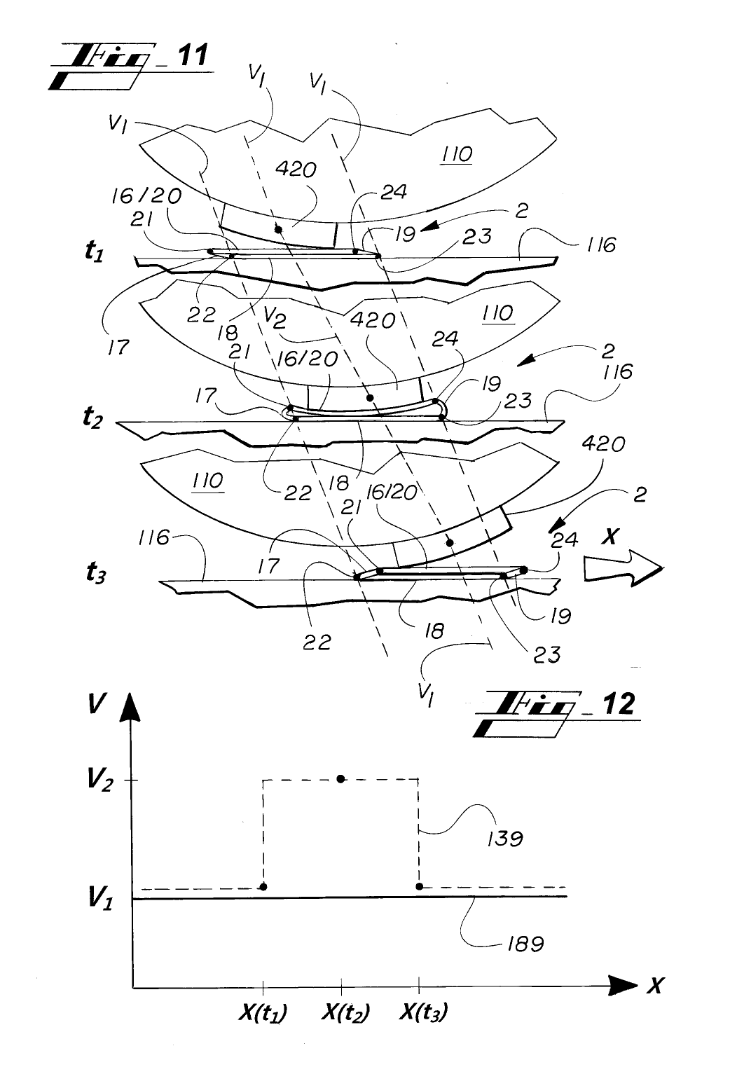

Referring to FIG. 9 and a time t1 of FIG. 11, the folding wheel 110 moves the pad 420 into initial frictional engagement with the outer top panel 16 of the collapsed carton 2. For example, at the time t1 and just before, the velocity of the folding wheel 110 is approximately a velocity v1—the same as the bottom center belt 116, the first lug assembly 68, and the second lug assembly 80. Referring to the time between the time t1 and a time t3 (including a time t2) of FIG. 11 and FIG. 12, the folding wheel 110 accelerates while the bottom center belt 116 remains at constant velocity v1. For simplicity, the acceleration is represented by a higher constant velocity v2 in FIGS. 11 (for the time between time t1 and time t3) and FIG. 12. However, the velocity profile of the folding wheel 110 includes functions other than a step function. For example, the acceleration is generally not instantaneous and the velocity profile may be shaped more like a bell curve. In FIGS. 11 and 12, “X” represents position along the path 43.

Generally, the folding wheel 110 and bottom center belt 116 operate at different speeds to accelerate (shift forward) the top of the carton 2 with respect to the bottom of the carton 2, flipping it forward. Due to the acceleration of the folding wheel 110, the pad 420 moves the outer top panel 16/inside top panel 20 in the downstream direction faster than the bottom center belt 116 moves the bottom panel 18 in the downstream direction. As a result, the carton 2 is folded along the fold line 21, the fold line 22, the fold line 23, and the fold line 24. Particularly, the first side panel 17, which begins in overlapping contact with the outer top panel 16/inside top panel 20 and coplanar with the bottom panel 18, is folded one hundred eighty degrees along the fold line 22 to be in overlapping contact with the bottom panel 18 and coplanar with the outer top panel 16/inside top panel 20. The second side panel 19, which begins in overlapping contact with the bottom panel 18 and coplanar with the outer top panel 16/inside top panel 20, is folded one hundred and eighty degrees along the fold line 23 to be in overlapping contact with the outer top panel 16/inside top panel 20 and coplanar with the bottom panel 18.

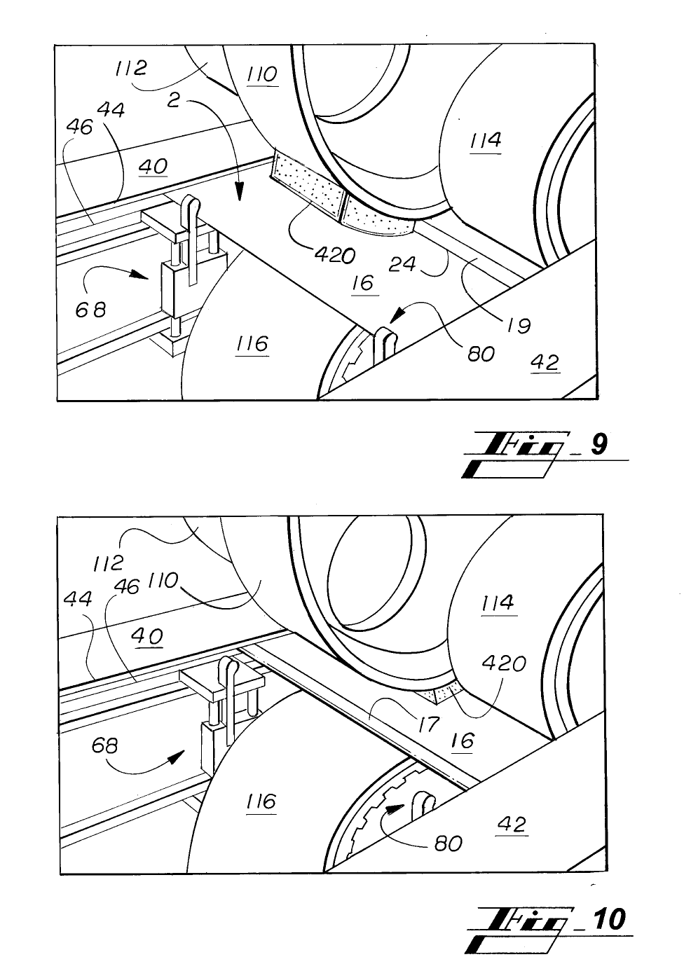

Referring to FIGS. 9 and 10, the folding of the carton 2 due to the acceleration of the folding wheel 110 pulls the carton 2 from engagement with the first lug assembly 68 and the second lug assembly 80. Thereafter, the first lug assembly 68 and the second lug assembly 80 are lowered according to the path of the cam track 94 (see FIG. 7). The first lug assembly 68 and the second lug assembly 80 are lowered to avoid the first top folding belt 112 and the second top folding belt 114.

The first top folding belt 112 and the second top folding belt 114 are configured to maintain the folded condition of the carton 2 (e.g., the folded condition at time t3) such that the carton 2 does not revert to the initial collapsed condition (e.g., the folded condition at time t1). The first top folding belt 112 and the second top folding belt 114 engage the carton 2 before the carton 2 is disengaged by the folding wheel 110.

Referring to FIGS. 4 and 5, the top center belt 118 engages the carton 2 before the carton 2 is disengaged by the first top folding belt 112 and the second top folding belt 114. In addition to the bottom center belt 116 and the top center belt 118, the carton 2 is then additionally engaged by the first bottom outside belt 120, the second bottom outside belt 122, the first top outside belt 124, and the second top outside belt 126.

The carton 2 is then disengaged by the first bottom outside belt 120, the second bottom outside belt 122, the first top outside belt 124, and the second top outside belt 126 such that the carton 2 can be engaged by the second conveying system 38. Particularly, the bottom center belt 116 and the top center belt 118 continue to engage the center of the carton 2 and position the carton 2 such that the upstream edge near the opposed ends of the carton 2 can be engaged by the first upstream lug 384 and the second upstream lug 392. Further, the ends of the carton 2 are supported by the third guide 360 and the fourth guide 362.

Just before or after the carton 2 is engaged by the first upstream lug 384 and the second upstream lug 392, the carton 2 is disengaged by the top center belt 118. The first upstream lug 384 and the second upstream lug 392 engage the carton 2 and pull the carton 2 from the bottom center belt 116 and move the carton 2 along the third guide 360 and the fourth guide 362. Having been folded and flattened by the flattening system 36, the carton 2 is ready to be erected as a tubular structure.

To square the walls of the tubular structure of the carton 2, the first downstream lug 400 and the second downstream lug 408 move into position to engage the second side wall 10 (downstream edge) of the carton 2. The first upstream lug 384 and the second upstream lug 392 engage the first side wall 6 and the first downstream lug 400 and the second downstream lug 408 engage the second side wall 10 to square the carton 2. The squared carton 2 is moved through the gluing station 39 where the top end flap 25 and the bottom end flap 26 are folded and secured to one another to form the end wall 12. Once the end wall 12 is formed, the carton 2 remains in a squared condition and is configured to receive an insert. For example, the carton 2 is configured to be loaded with a blister card.

The above-described embodiments are merely exemplary illustrations of implementations that are set forth for a clear understanding of principles. Variations, modifications, and combinations may be made to the above-described embodiments may be made without departing from the scope of the claims. All such variations, modifications, and combinations are included herein by the scope of this disclosure and the following claims.

What is claimed is:

1. A container erecting system, comprising:
a first conveying system;
a folding wheel comprising an engaging surface;
a flattening system comprising a bottom center belt, the bottom center belt comprising an engaging surface;
wherein the first conveying system is configured to convey a collapsed container to a position at which the engaging surface of the folding wheel is configured to engage a top panel of the collapsed container and the engaging surface of the bottom center belt is configured to engage a bottom panel of the collapsed container; and
a controller that is configured to control a first speed of the engaging surface of the folding wheel in a downstream direction with respect to a second speed of the engaging surface of the bottom center belt in the downstream direction, the first speed being different from the second speed within a folding time period.

2. The erecting system of claim 1, wherein a difference between the first speed being and the second speed is determined such that one of the top panel and the bottom panel is folded downstream with respect to the other of the top panel and the bottom panel.

3. The container erecting system of claim 1, wherein the position is between the engaging surface of the folding wheel and the engaging surface of the bottom center belt.

4. The container erecting system of claim 1, wherein the first speed is greater than the second speed within the folding time period.

5. The container erecting system of claim 1, wherein the first speed is less than the second speed within the folding time period.

6. The container erecting system of claim 1, wherein the controller is configured to control the first speed according to a cam profile.

7. The container erecting system of claim 1, wherein the first speed is equal to the second speed at a beginning and at an end of the time period.

8. The container erecting system of claim 1, further comprising a driving mechanism that is configured to drive the folding wheel, wherein the controller is configured to control an input to the driving mechanism.

9. The container erecting system of claim 1, further comprising a top center belt comprising an engaging surface, wherein the engaging surface of the top center belt is:
downstream of the engaging surface of the folding wheel; and
above the engaging surface of the bottom center belt.

10. The container erecting system of claim 9, further comprising:
a first top outside belt and a second top outside belt being positioned on opposite sides of the top center belt; and
a first bottom outside belt and a second bottom outside belt being positioned on opposite sides of the bottom center belt.

11. The container erecting system of claim 9, further comprising a first top folding belt and a second top folding belt that are positioned on opposite sides of the folding wheel and the top center belt;
wherein an upstream edge of an engaging surface of each of the first top folding belt and the second top folding belt is upstream from a downstream edge of the engaging surface of the folding wheel; and
wherein a downstream edge of the engaging surface of each of the first top folding belt and the second top fold belt is downstream from an upstream edge of the engaging surface of the top center belt.

12. The container erecting system of claim 11, further comprising:
a first top outside belt and a second top outside belt that are positioned on opposite sides of the top center belt; and
a first bottom outside belt and a second bottom outside belt that are positioned on opposite sides of the bottom center belt.

13. The container erecting system of claim 12, wherein an engaging surface of the first top outside belt is above an engaging surface of the first bottom outside belt; and
wherein an engaging surface of the second top outside belt is above an engaging surface of the second bottom outside belt.

14. The container erecting system of claim 13, wherein the engaging surface of the first top outside belt is downstream from the engaging surface of the first top folding belt; and
wherein the engaging surface of the second top outside belt is downstream from the engaging surface of the second top folding belt.

15. The container erecting system of claim 1, the first conveying system comprising:
a guide; and
a lug assembly that is configured to contact an upstream edge of a collapsed container to push the collapsed container in a downstream direction along the guide.

16. The container erecting system of claim 15, the first conveying system comprising a suction device that is configured to extract a collapsed container from a hopper and position the collapsed container on the guide.

17. The container erecting system of claim 1, further comprising a second conveying system, wherein the second conveying system is configured to convey a container from a downstream end of the flattening system.

18. The container erecting system of claim 17, the second conveying system comprising a lug assembly that is configured to engage an upstream end of a container upstream of a downstream edge of the bottom center belt.

19. The container erecting system of claim 18, the second conveying system comprising a lug assembly that is configured to engage a downstream end of a container.

20. A method, comprising:
Receiving, between a top engaging surface of a top folding structure and a bottom engaging surface of a bottom folding structure, a collapsed container, wherein the collapsed container is received from a conveying system, the receiving step comprising:
engaging a top panel of the collapsed container with the top engaging surface; and
engaging a bottom panel of the collapsed container the bottom engaging surface; and
controlling, by a processor, a first speed of the top engaging surface in a downstream direction with respect to a second speed of the bottom engaging surface in the downstream direction such that the first speed is different from the second speed within a folding time period.
